(19) United States
(12) Patent Application Publication
(10) Pub. No.: US 2021/0184854 A1
(43) Pub. Date: Jun. 17, 2021

(54) DEVICE VALIDATION USING TOKENS

(71) Applicant: Hewlett-Packard Development Company, L.P., Spring, TX (US)

(72) Inventors: Laurent Pizot, Vancouver, WA (US); Roger S Twede, Boise, ID (US)

(21) Appl. No.: 17/250,691

(22) PCT Filed: Nov. 30, 2018
(86) PCT No.: PCT/US2018/063191

§ 371 Date: Feb. 19, 2021

(51) Int. Cl. H04L 9/32; H04L 9/08; H04L 29/06

(52) U.S. Cl. CPC H04L 9/3213; H04L 9/3247; G06F 21/608; H04L 9/0827; H04L 63/0823; H04L 9/3297

(57) ABSTRACT

The present subject matter relates to techniques for validating an electronic device using tokens. In an example, the technique may include generating a token based on a unique identifier of the electronic device, a device signature, and a time-stamp of the electronic device. The token is shared with a user device to establish a session. The token is rotated at a fixed time interval. Upon successful verification of the token, a command received from the user device is executed on the electronic device.

### BACKGROUND

A device, such as a printing device, may be equipped with a capability of transmitting beacons. The beacons include device specific information, such as a unique identifier of the device, for being shared with personal mobile devices of users. Based on the unique identifier, the users may establish a session with the device to execute a command sent by the personal mobile devices of the users.

### BRIEF DESCRIPTION OF FIGURES

The detailed description is provided with reference to the accompanying figures, wherein:

FIG. 1 illustrates an electronic device, according to an example:

FIG. 2 illustrates an example of a network environment employing the electronic device, according to an example;

FIGS. 3A-3D illustrate call flow diagrams for device validation using tokens, according to an example;

FIG. 4 illustrates a method for device validation using tokens, according to an example; and

FIG. 5 illustrates a non-transitory computer readable medium for device validation using tokens, according to an example.

### DETAILED DESCRIPTION

Beacons are used for transmitting data over short distances via radio waves. The beacons are advertised or broadcasted for being discovered by user devices, such as smartphones, mobile phones. When a user walks past a device broadcasting the beacons, a beacon sends a code, such as an identifier of the device, to a user device. The code may be read by an application, such as a third-party application installed on the user device to communicate or establish a session with the device broadcasting the beacon.

As the beacons are public advertisements, the beacons once discovered may be recorded and reused to deceive a user device in an attempt to maliciously collect data from the users. Alternatively, the beacons may also be anticipated and may be used to attack devices in a cloud environment. Thus, the beacons may cause the unintended users from stealing users' content.

The present subject matter discloses approaches for protecting users' content from unintended users, by including a device signature in a token transmitted by an electronic device, such as a printer. The token is rotated at a fixed time interval such that a frequency of rotation of the token is different from a frequency of rotation of the device signature. In an example, the device signature may be signed by a time-stamp of the electronic device. As the token includes the time-stamp of the electronic device, the rotatable token cannot be re-used by the unintended users.

In various implementations, the present subject matter describes approaches for validating an electronic device based on tokens. In an example, a token may be a data packet that may be transmitted by an electronic device, such as the printer. The electronic device may generate the token that may be specific to the electronic device which is to be validated. The token includes a unique identifier of the electronic device, the device signature, and the time-stamp of the electronic device. The device signature may include a cryptographic key or a random value. In an example, the cryptographic key is exchanged between the electronic device and an authentication server, when the electronic device registers with the authentication server. Further, the random value may be generated by the electronic device.

The electronic device shares the token with multiple user devices, either through short range communication technologies or through wide range communication technologies. The token is rotated at a fixed time interval. For example, upon expiry of the fixed time interval, the token is modified and re-shared with the user devices. The inclusion of the device signature ensures that the token cannot be reused by anyone. Upon receiving the token, a user device may communicate with the electronic device using the token. For example, the user device may send a transaction request to the electronic device. The transaction request may include a command to be executed by the electronic device and the token.

In an implementation, the transaction request may be received by the electronic device or by a cloud server associated with the electronic device. In case the user device sends the transaction request directly to the electronic device, the electronic device may validate the token based on a comparison between the device signature retrieved from the transaction request and the device signature stored in the electronic device. Upon successful validation of the token, the electronic device may execute the command included within the transaction request.

In another implementation, when the transaction request is shared with the cloud server, the cloud server may validate the token based on comparison of the device signature retrieved from the transaction request and the device signature stored by the authentication server. Upon successful validation of the token, the cloud server may either execute the command or may forward the command contained in the transaction request to the electronic device for execution. Accordingly, the device signature facilitates in securing an identity of the electronic device against misuse.

The present subject matter is further described with reference to the accompanying figures. Wherever possible, the same reference numerals are used in the figures and the following description to refer to the same or similar parts. It should be noted that the description and figures merely illustrate principles of the present subject matter, it is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

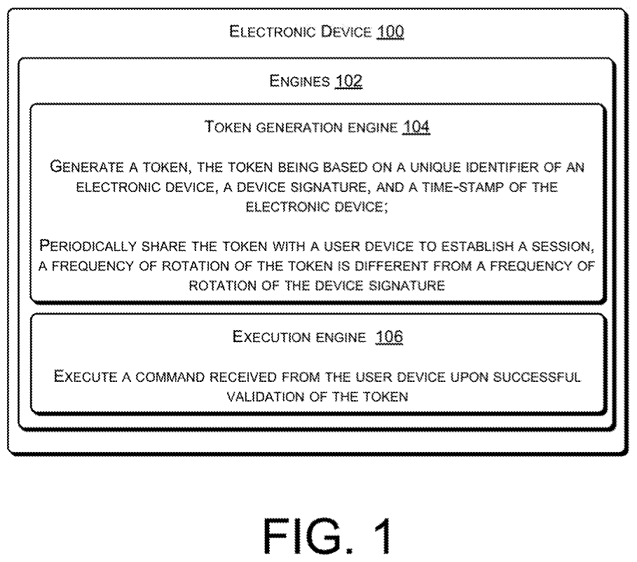

The manner in which the tokens are used for validating identity of an electronic device is implemented are explained in detail with respect to FIGS. 1-5. While aspects of described electronic device can be implemented in any number of different computing systems, environments, and/or implementations, the examples are described in the context of the following device(s).

FIG. 1 illustrates an electronic device 100, according to an example. The electronic device 100 may include, for example, engines 102. The engines 102, amongst other things, include routines, programs, objects, components, and data structures, which perform particular tasks or implement particular abstract data types. The engines 102 may also be implemented as, signal processor(s), state machine(s), logic circuitries, and/or any other device or component that manipulates signals based on operational instructions. Further, the engines 102 can be implemented by hardware, by computer-readable instructions executed by a processing unit, or by a combination thereof.

The engines 102 may include a token generation engine 104 that may generate a token for the electronic device 100. The token may be based on a universal unique identifier (UUID) of the electronic device 100, a device signature, and a time-stamp of the electronic device 100. In art example, the device signature may include a cryptographic key. When the token includes the cryptographic key, the token may be referred to as Mode 0 token. In another example, the device signature may be a random value that may be generated by the electronic device 100. When the token includes the random value, the token may be referred to as Mode 1 token, in an example, the time-stamp may be inserted in the device signature of both the Mode 0 and Mode 1 tokens, in another example, the time-stamp may be inserted in the device signature of the Mode 0 token, in this case, the Mode 1 token may include any contextual data that may indicate which random value is being used in the token.

Further, the token generation engine 104 may periodically share the token with various user devices (not shown). For example, the token may be shared for a fixed time duration, such as 8 seconds. After completion of the fixed time duration, the token may be re-generated and shared again. The periodic sharing of the token, in modified or regenerated form, ensures that the same token cannot be used again for carrying out transactions with the electronic device 100, In an example, a frequency of rotation of the token may be different from a frequency of rotation of the device signature. Referring to the above example, the frequency of rotation of the token may be 8 seconds. 10 seconds, and so on, and the frequency of rotation of the device signature may be 1 min, 5 mins, 5 hours, 1 day, and so on.

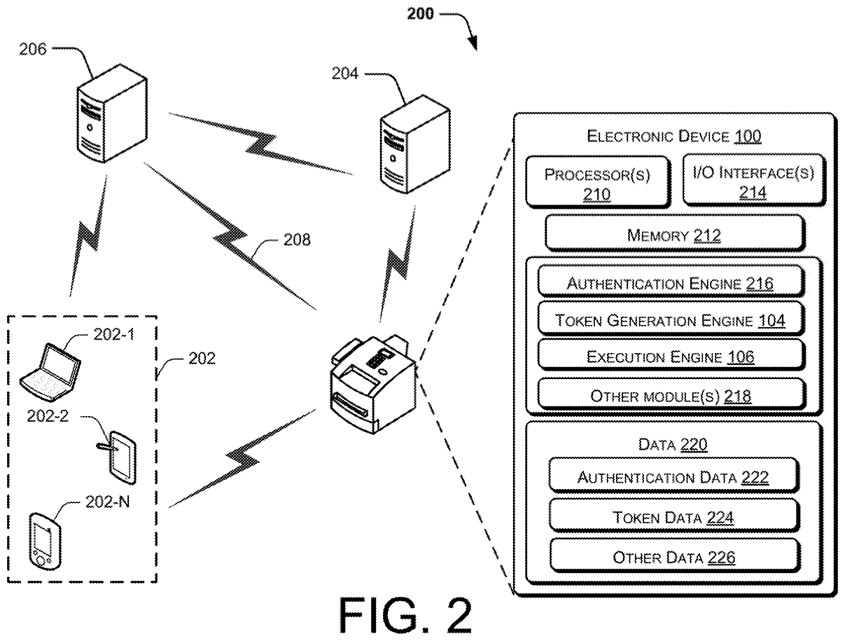

According to an example, the engines 102 may include an execution engine 106 that may execute the command received from a user device upon successful validation of the token. In the present example, the token may be validated either by the electronic device 100 or by a cloud server (not shown). For example, the electronic device 100 may maintain a list of shared tokens and validate the token received from the user device with a recently generated token in the list of shared tokens. Upon successful validation of the token, the command included in the transaction request may be executed by the execution engine 108. In case the token is not validated successfully, the command may be rejected and the user device may have to receive a new token from the electronic device 100 to communicate with the electronic device 100. As the token generated based on the device signature is specific to the electronic device 100, the token may not be reproduced by outside parties. Thereby, the tokens facilitate in authenticating the identity of the electronic device 100 and protecting users' content from being misused. A manner by which the tokens are used to validate the electronic device 100 is explained with respect to FIG. 2.

FIG. 2 illustrates a network environment 200 employing the electronic device 100. Examples of the electronic device 100 may include, but are not limited to, a printer, a scanner, multi-function printer, and so on. The electronic device 100 may communicate with a plurality of user devices, such as 202-1, 202-2, 202-M, collectively referred to as user devices 202 and individually referred to as a user device 202. In an example, the user devices 202 can be portable and can be of different types. For instance, the user devices 202 can be a mobile phone, a laptop, a smartphone, or the like.

The network environment 200 may also include an authentication server 204 in communication with the electronic device 100, In an example, the electronic device 100 may be registered with the authentication server 204. Based on the registration, the authentication server 204 and the electronic device 100 may exchange the device signature, such as a cryptographic key, over a key agreement protocol (KPA).

Further, the electronic device 100 may be in communication with a cloud server 206. The cloud server 206 may provide cloud services to transact with any web-connected electronic device by routing commands from the user devices 202 to the web-connected electronic device. In an example implementation, the cloud server 206 may be time synchronized with the electronic device 100. The time synchronization may prevent any drift in timings of the cloud server 206 and the electronic device 100. For instance, a clock of the electronic device 100 and the cloud server 208 may be synchronized with each other to reflect the time starting from a reference clock. The time synchronization between the cloud server 206 and the electronic device 100 facilitates in preventing malicious users to steal users' content by validating transaction requests received from the user devices 202. The cloud server 206 facilitates in validating the transaction requests received from the user devices 202. The cloud server 206 may be authorized by the authentication server 204 to validate the transaction requests for the electronic device 100.

According to an example, the electronic device 100 may communicate with the user devices 202, the authentication server 204, and the cloud server 206 over a communication network 208. The communication network 208 may be a wireless network, a wired network, or a combination thereof. The communication network 208 can also be an individual network or a collection of many such individual networks, interconnected with each other and functioning as a single large network, e.g., the Internet or an intranet. The communication network 208 can be employed as one of the different types of networks, such as intranet, local area network (LAN), wide area network (WAN), the internet, and such. The communication network 208 may either be a dedicated network or a shared network, which represents an association of the different types of networks that use a variety of protocols, for example, Hypertext Transfer Protocol (HTTP), Transmission Control Protocot/Internet Protocol (TCP/IP), etc., to communicate with each other. Further, the communication network 208 may include network devices, such as network switches, hubs, routers, for providing a link between the electronic device 100 and the user devices 202 or the authentication server 204 or the cloud server 208. The network devices within the communication network 208 may interact with the electronic device 100, the user devices 202, the authentication server 204, and the cloud server 206, through the communication Sinks.

In one example; the electronic device 100 includes a processor 210 and a memory 212 coupled to the processor 210. The processor 210 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions.

The memory 212, communicatively coupled to the processor 210, can include any non-transitory computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

The electronic device 100 also includes an interface 214. The interface 214 may include a variety of interfaces, for example, interfaces 214 for user devices 202. The interface 214 may include data output devices. The interface 2:14 facilitates communication between the electronic device 100 and various communication and computing devices and various communication networks, such as networks that use a variety of protocols, for example, Real Time Streaming Protocol (RTSP), Hypertext Transfer Protocol (HTTP), Live Streaming (HLS) and Real-time Transport Protocol (RTP).

Further, as described with reference to FIG. 1, the electronic device 100 includes engines 102. In one example, the engines 102 include an authentication engine 216, the token generation engine 104, the execution engine 106, and other engine(s) 218. The other engine(s) 218 may include programs or coded instructions that supplement the applications or functions performed by the electronic device 100. The engines 102 may be implemented as described in relation to FIGS. 1 and 2.

In an example, the electronic device 100 includes data 220. The data 220 may include an authentication data 222, a token data 224, and other data 228. The other data 228 may include data generated and saved by the engines 102 for implementing various functionalities of the electronic device 100.

As explained previously, the tokens generated by the electronic device 100 includes the device signature which facilitates in validating the identity of the electronic device 100, In an example implementation, to generate Mode 0 tokens, the electronic device 100 may exchange the device signature, such as a cryptographic key, with the authentication server 204. To do so, the authentication engine 216 of the electronic device 100 may register the electronic device 100 with the authentication server 204. In an example, the authentication engine 218 may share an authentication certificate of the electronic device 100 with the authentication server 204, For example, the authentication engine 216 may share an authentication certificate of the electronic device 100 with the authentication server 204. The authentication certificate Is an electronic document that identifies the electronic device 100 and associates an identity, such as the UUID of the electronic device 100 with a public key. In addition to the public key, the authentication certificate includes a name of the electronic device 100, an expiration date of the authentication certificate, a name of an issuing authority, and so on.

Based on the information in the authentication certificate, the authentication server 204 may generate a set of one-time cryptographic keys for the electronic device 100. In an example, the authentication server 204 may store the set of one-time cryptographic keys in a database associated with the authentication server 204. For instance, the database may be a key management system. Further, the authentication server 204 and the electronic device 100 may exchange a cryptographic key from the set of one-time cryptographic keys over a key agreement protocol (KPA), Examples of the KPA include, but are not limited to, Diffie-HelSman (DH) key exchange and Rivest-Shamir-Adleman (RSA) key exchange mechanism (RSA-KEM).

In another example implementation, to generate Mode 1 tokens, the authentication engine 216 may generate the device signature, such as a random value, for the electronic device 100. In an example, the authentication engine 216 may employ a Pseudo Random Number Generator (PRNG) or a Cryptographically Secure Random Number Generator (CSRNG), to generate the random value. The authentication engine 216 may store the set of one-time cryptographic keys and a list of random values as the authentication data 222.

Further, the token generation engine 104 may generate a token (Mode 0 or Mode 1) for being transmitted by the electronic device 100. The token may be based on a universal unique identifier (UUID) of the electronic device 100, the device signature, and a time-stamp of the electronic device 100. The device signature in the Mode 0 token may include the cryptographic key exchanged with the authentication server 204. The device signature in the Mode 1 token may include the random value generated by the electronic device 100. In an example, the device signature may be embedded with the time-stamp of the electronic device 100. In another example, the time-stamp may be inserted in the device signature of the Mode 0 token. In this case, the Mode 1 token may include any contextual data that may indicate which random value is being used in the token.

According to an example implementation, the token may have a length of about 20 bytes, in which about 16 bytes may be occupied by the UUID of the electronic device 100. The occupancy of the remaining four bytes of the token may vary based on the device signature included in the token. For example, to Mode-0, the remaining four bytes of the token may include a mode indicator, the cryptographic key, and the time-stamp of the electronic device 100. An exemplary format of allocation of the remaining 4 bytes of the token in Mode-0 is provided below:

| Mode | Time-stamp | Cryptographic Key |
|---|---|---|
| 2 bits | 6 bits | 3 least significant bytes (LSBs) |

The ‘Mode’ in the above format is indicative of a type of the device signature in the token. In Mode-0, the 2 bits may have a value of W indicating that a cryptographic key is used in the token. Further, the time-stamp of the electronic device 100 occupies 6 bits. Accordingly, the Mode and time-stamp fields occupy 1 byte of the remaining 4 bytes of the token. The 3 LSBs are occupied by the cryptographic key in the Mode 0 token.

In Mode-1, the remaining four bytes of the token may include a mode indicator, reserved bits, and the random value as generated by the electronic device 100. An exemplary format of allocation of the remaining 4 bytes of the token in Mode-1 is provided below:

| Mode | Reserved | Random Value |
|---|---|---|
| 2 bits | 6 bits | 3 least significant bytes (LSBs) |

In Mode-1, the 2 bits may have a value of ‘10’. Further, 6 bits may be reserved. In an example, the reserved bits may be used for a timestamp or any data that may identify which random value is used in the token. Further, the 3 LSBs are occupied by the random value in the token.

Further, the token generation engine 104 may share the token with the user devices 202. In an example, the token generation engine 104 may share the token with the user devices 202 over wide range communication technologies, such as Wi-Fi, Ethernet, wireless local area network (WLAN), and so on. Therefore, the user devices 202 may receive the token transmitted from the electronic device 100 even when the user devices 202 are not in a proximity of the electronic device 100. Further, while sharing the tokens over wide-range communication technologies, the token may not be broadcasted by the electronic device 100. In this case, to receive the token, the user devices 202 may send a request to the token generation engine 104.

In another example, the token generation engine 104 may share the tokens with the user devices 202 over short range communication technologies, such as Bluetooth®. In this example, the user devices 202 in proximity of the electronic device 100 may be able to receive the token. For short-range communication technologies, the token generation engine 104 may broadcast the token that may be detected by the user devices 202 proximal to the electronic device 100. Before sharing the token, the token generation engine 104 may store information pertaining to the remaining 4 bytes of the token as the token data 224.

In an example implementation, the token may be shared periodically with the user devices 202, For example, the token generation engine 104 may transmit the token for a fixed or pre-determined time interval, such as 8 seconds, 10 seconds, and so on. After expiry of the fixed time interval, the token may be re-generated by the token generation engine 104 and shared again. In an aspect, a frequency of rotation of the token may be different from a frequency of rotation of the device signature in the token.

For example, in case of Mode 0 tokens, the cryptographic key may have a rotation frequency of about 15 mins and a rotation frequency of the Mode 0 token may be 10 seconds. Accordingly, the token generation engine 104 may re-share the Mode 0 token alter every TO seconds with the UUID of the electronic device 100, the cryptographic key inserted with a new time stamp of the electronic device 100, After 15 mins, the token generation engine 104 may share the Mode 0 token with the UUID of the electronic device 100, a new cryptographic key inserted with a new time stamp of the electronic device 100. As the Mode 0 tokens involve cryptographic keys as the device signatures, the Mode 0 tokens ensure that the identity of the electronic device 100 is not compromised and a secure communication may be established between the electronic device 100 and the user devices 202.

In case of Mode 1 tokens, the device signature, i.e., random value may have a rotation frequency of about 5 mins and a rotation frequency of the Mode 1 token may be 5 seconds. Accordingly, the token generation engine 104 may re-share the Mode 1 token after every 5 seconds with the UUID of the electronic device 100, the random value inserted with a new time stamp of the electronic device 100. After 5 mins, the token generation engine 104 may share the Mode 1 token with the UUID of the electronic device 100 and a new random value. In addition, the Mode 1 token may include the time-stamp of the electronic device 100 or any data that may provide an indication about the random value being used in the Mode 1 token.

The user devices 202 may receive the tokens being shared by the token generation engine 104. In an example, the tokens (Mode 0 or Mode 1) may be broadcasted by the token generation engine 104 for being detected by the user devices 202. The tokens may be broadcasted over the short-range communication technologies. For instance, the user devices 202 may detect the broadcasted tokens over Bluetooth®. In another example, the user devices 202 may request the electronic device 100 to share the token, such as over Wi-Fi.

Upon receiving the token, the user devices 202 may communicate with the electronic device 100. For example, the user devices 202 may send a transaction request to the electronic device 100 based on the token received from the electronic device 100. The transaction request may include a command for being executed by the electronic device 100 and the token as received by the user device 202.

In an example, the user device 202 may send the transaction requests directly to the electronic device 100. For example, the user device 202 may send a print command along with the token to the electronic device 100. Upon receiving the transaction request, the execution engine 106 of the electronic device 100 may compare the token received from the user device 202 with the token data 224. For example, the execution engine 106 may compare the device signature mentioned in the token (Mode 0 or Mode 1) with a list of recently shared tokens that were shared by the electronic device 100. If the device signature matches a recently shared device signature from the list, the execution engine 106 may validate the token. In an example, the execution engine 106 may also compare the time-stamp associated with the tokens.

Upon successful validation of the token, the execution engine 106 may execute the print command as per the transaction request. In an example, to complete the print command, a user of the user device 202 may or may not have to provide input, such as pressing a key, on the electronic device 100.

In another example, the user device 202 may send the transaction request to the cloud server 206 for validation of the token in the transaction request. For example, the transaction request received from the user device 202 may include a command to scan and store a document to a user's cloud storage. In case of Mode-0 token, the cloud server 206 may, in order to validate the Mode-0 token, query the authentication server 204 to access the limited set of one-time cryptographic keys generated for the electronic device 100. The cloud server 206 may then compare the cryptographic key in the token received from the user device 202 with the limited set of one-time cryptographic keys. Upon successful validation, the cloud server 206 may route the scan and store command to the electronic device 100 for execution by the execution engine 106. Alternatively, the cloud server 206 may execute the command as sent by the user device 202.

In case of Mode-1 token, the cloud server 206 may query the electronic device 100 to check validity of the token. The electronic device 100 may compare the random value included in the token received from the user device 202 with the list of random values generated for the electronic device 100. The electronic device 100 may provide a response of the comparison to the cloud server 206. Upon successful validation, the cloud server 206 may route the scan and store command to the electronic device 100 for execution by the execution engine 106. Alternatively, the cloud server 206 may execute the command. Due to the validation of the tokens, Mode-0 as well as Mode-1, the identity of the electronic device 100 is validated. Accordingly, if may be ensured that the data received from the user devices 202 is not going to unintended users.

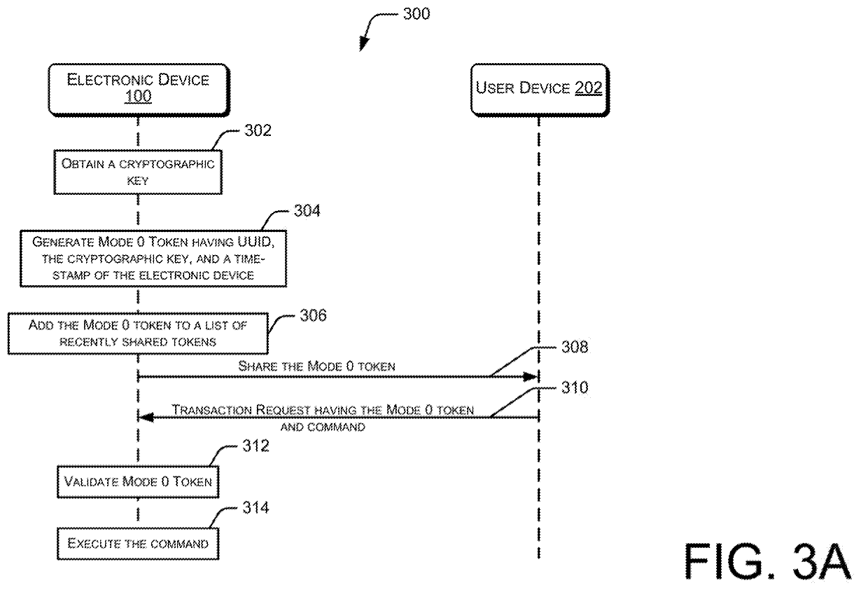

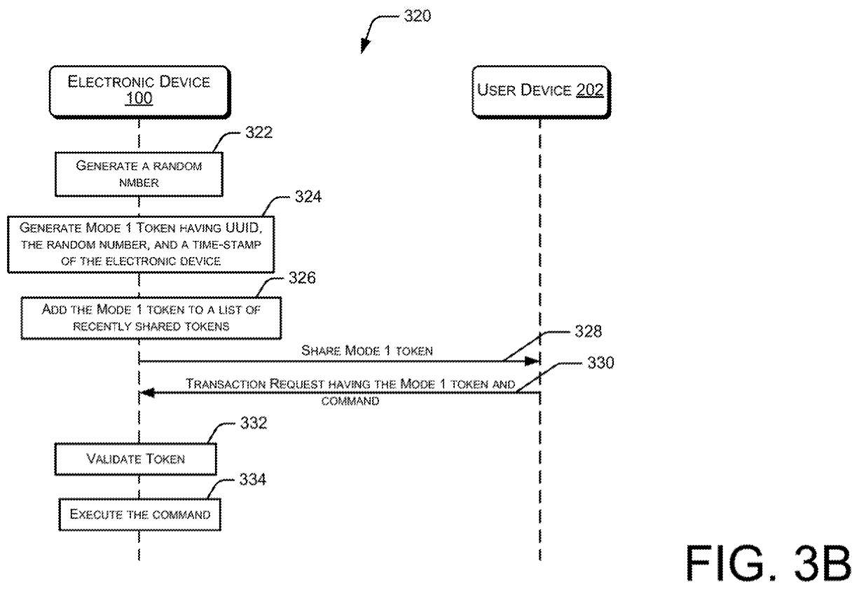

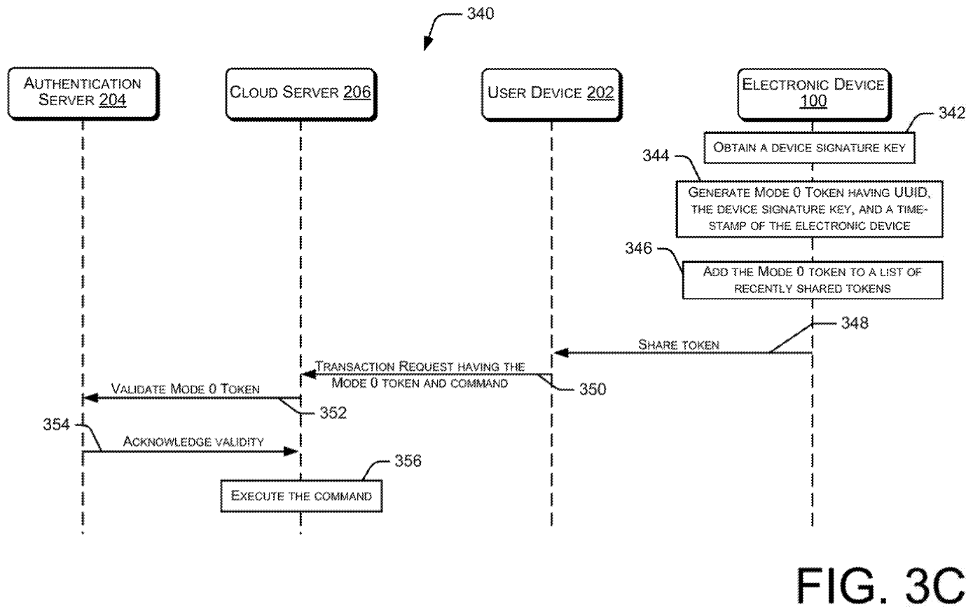

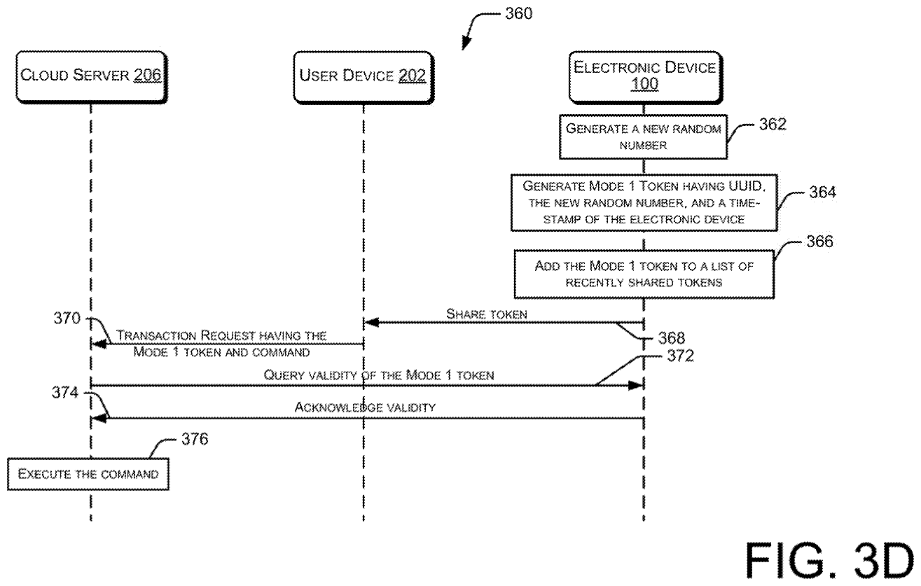

FIGS. 3A-3D illustrate call flow diagrams 300, 320, 340, and 360 for device validation using tokens, according to an example of the present subject matter. The various arrow indicators used in the call-flow diagrams 300, 320, 340, and 360 depict the transfer of data between the various entities in the network environment 200 and between the electronic device 100, the user device 202, the authentication server 204, and the cloud server 206. Although the description of FIGS. 3A-3D has been made in considerable detail with respect to the communication network 208, it will be understood that the steps for device validation using tokens can be implemented in other networks as well, albeit with few alterations. Further, certain trivial steps have been omitted in the sequence diagrams, for the sake of brevity and clarity.

Referring to FIG. 3A, the device validation may be performed by the electronic device 100 based on a cryptographic key. At step 302, the electronic device 100 may obtain a device signature. The device signature may include a cryptographic key exchanged with an authentication server 204, To receive the cryptographic key, the electronic device 100 may send a registration request to the authentication server 204.

In an example, the electronic device 100 may send an authentication certificate for the electronic device 100 in the registration request. The authentication certificate is an electronic document that identifies the electronic device 100 and associates an identity, such as a universal unique identifier (UUID) of the electronic device 100 with a public key. The authentication server 204 may, based on the information of the authentication certificate, generate a limited set of one-time cryptographic keys for the electronic device 100. The authentication server 204 may store the set of one-time cryptographic keys in a database associated with the authentication server 204. Further, the authentication server 204 and the electronic device 100 may exchange a cryptographic key from the set of one-time cryptographic keys over a key agreement protocol (KPA).

At step 304, the electronic device 100 may generate a Mode 0 token based on a unique identifier of the electronic device 100, the device signature, and a time-stamp of the electronic device 100. As mentioned above, when the token includes the unique identifier of the electronic device 100 and the cryptographic key, the token is considered as Mode 0 token. In case of Mode 0 tokens, the cryptographic key is signed with a time-stamp of the electronic device 100.

At step 308, the electronic device 100 may add the Mode 0 token to a list of recently generated tokens in an internal memory of the electronic device 100.

Further, at step 308, the electronic device 100 may share the Mode 0 token with the user device 202. The Mode 0 token may be shared over short-range communication technologies or wide-range communication technologies.

At step 210, the electronic device 100 may receive a transaction request from the user device 202, in an example, the transaction request may include a command to be executed and the Mode 0 token.

At step 312, the electronic device 100 may validate the Mode 0 token by comparing the Mode 0 token received from the user device 202 with the list of recently shared tokens stored locally in the electronic device 100. The electronic device 100 may communicate with the user device 202 to provide a response of the comparison.

At step 314, the electronic device 100 may upon successful validation of the Mode 0 token, execute the command as per the transaction request.

Referring to FIG. 3B, the device validation may be performed by the electronic device 100 based on a random value. At step 322, the electronic device 100 may obtain a device signature. The device signature may include a random value generated by the electronic device 100, In an example, the authentication engine 218 may employ a Pseudo Random Number Generator (PRNG) or a Cryptographically Secure Random Number Generator (CSRNG), to generate the random value.

At step 324, the electronic device 100 may generate a Mode 1 token based on a unique identifier of the electronic device 100, the device signature, and a time-stamp of the electronic device 100 or any data that may provide an indication about the random value being used in the Mode 1 token. As mentioned above, when the token includes the unique identifier of the electronic device 100 and the random value, the token is considered as Mode 1 token.

At step 326, the electronic device 100 may add the Mode 1 token to a list of recently generated tokens in an internal memory of the electronic device 100.

Further, at step 328, the electronic device 100 may share the Mode 1 token with the user device 202. The Mode 1 token may be shared over short-range communication technologies or wide-range communication technologies.

At step 330, the electronic device 100 may receive a transaction request from the user device 202. In an example, the transaction request may include a command to be executed and the Mode 1 token.

At step 332, the electronic device 100 may validate the Mode 1 token by comparing the Mode 1 token received from the user device 202 with the list of recently shared tokens stored locally in the electronic device 100. The electronic device 100 may communicate with the user device 202 to provide a response of the comparison.

At step 334, the electronic device 100 may upon successful validation of the Mode 1 token, execute the command as per the transaction request.

Now referring to FIG. 3C, the device validation may be performed by the cloud server 206. At step 342, the electronic device 100 may obtain a device signature. The device signature may include a cryptographic key exchanged with the authentication server 204. To receive the cryptographic key, the electronic device 100 may send a registration request to the authentication server 204.

At step 344, the electronic device 100 may generate a Mode 0 token based on a unique identifier of the electronic device 100, the device signature, and a time-stamp of the electronic device 100.

At step 346, the electronic device 100 may add the Mode 0 token to a list of recently generated tokens in an infernal memory of the electronic device 100.

Further, at step 348, the electronic device 100 may share the Mode 0 token with the user device 202. The Mode 0 token may be shared over short-range communication technologies or wide-range communication technologies.

At step 350, the user device 202 may send the transaction request to the cloud server 206. As explained with respect to FIG. 2, the cloud server 208 may be time synchronized with the electronic device 100. The time synchronization may prevent any drift in timings of the cloud server 206 and the electronic device 100. Thus, the clock of the cloud server 208 and the electronic device 100 may have the same time.

To validate the token, the cloud server 206 may request the authentication server 204 to check if the device signature of the Mode 0 token is present in a list of recently shared device signatures. In an example, the list of recently shared device signatures includes the limited set of one-time cryptographic keys, as depicted in step 352, In an example, the cloud server 206 may query the list of recently shared device signatures from the authentication server 204. The cloud server 206 may then compare the device signature to validate the token. For example, the cloud server 206 may compare the time-stamp on the cryptographic key with the time-stamp of the cloud server 208, As the cloud server 206 and the electronic device 100 are time synchronized, the time-stamp of the cloud server 206 and the electronic device 100 is same. Further, the cloud server 206 may compare the cryptographic; key in the Mode 0 token with the list of cryptographic keys exchanged with the authentication server 204.

At step 354, the authentication server 204 may acknowledge the validity of the Mode 0 token to the cloud server 206, based on comparison of the device signatures.

At step 358, the cloud server 206 may upon successful validation of the Mode 0 token, execute the command as per the transaction request and provide an output to the user device 202. Alternatively, the cloud server 208 may route the command to the electronic device 100 for execution.

Now referring to FIG. 30, the device validation may be performed by the cloud server 208 based on a random value. At step 362, the electronic device 100 may obtain a device signature. The device signature may include a random value generated by the electronic device 100.

At step 384, the electronic device 100 may generate a Mode 1 token based on a unique identifier of the electronic device 100, the device signature, and a time-stamp of the electronic device 100 or any data that may provide an indication about the random value being used in the Mode 1 token.

At step 368, the electronic device 100 may add the Mode 1 token to a list of recently generated tokens in an internal memory of the electronic device 100. Further, at step 368, the electronic device 100 may share the Mode 1 token with the user device 202.

At step 370, the user device 202 may send the transaction request to the cloud server 208. In addition, at step 372, the cloud server 206 may query the electronic device 100 to check a validity of the Mode 1 token received from the user device 202. In an example, to validate the token, the cloud server 208 may request the electronic device 100 to check if the device signature of the Mode 1 token is present in a list of recently shared device signatures. In an example, the list of recently shared device signatures includes the random values generated by the electronic device 100. In another example, the cloud server 206 may query the list of recently shared device signatures from the electronic device 100. The cloud server 206 may then compare the device signature to validate the Mode 1 token. For instance, the cloud server 206 may compare the random value in the Mode 1 token with the list of random values generated by the electronic device 100.

At step 374, the electronic device 100 may acknowledge the validity of the Mode 1 token to the cloud server 206, based on comparison of the device signatures.

At step 376, the cloud server 206 may upon successful validation of the Mode 1 token, execute the command as per the transaction request and provide an output to the user device 202. Alternatively, the cloud server 206 may route the command to the electronic device 100 for execution.

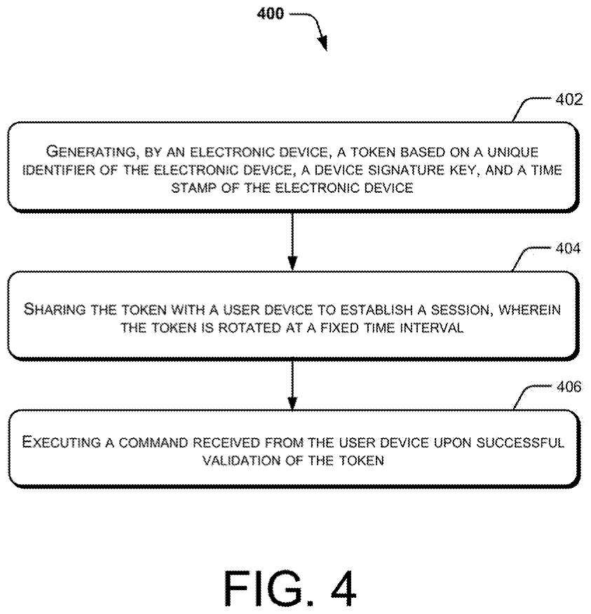

FIG. 4 illustrates a method 400 for device validation based on tokens, according to an example of the present subject matter. The method 400 may be described in the general context of computer executable instructions. The method 500 can be implemented by processors) or device(s) through any suitable hardware, a non-transitory machine readable medium, or a combination thereof. Further, although the method 400 is described in context of a device that is similar to the electronic device 100, other suitable devices or systems may be used for execution of the method 400.

The order in which the method 400 is described is not intended to be construed as a limitation, and any number of the described method blocks may be combined in any order to implement the method 400, or an alternative method. In some example, blocks of the method 400 may be executed based on instructions stored in a non-transitory computer-readable medium. The non-transitory computer-readable medium may include, for example, digital memories, magnetic storage media, such as a magnetic disks and magnetic tapes, hard drives, or optically readable digital data storage media.

Referring to FIG. 4, at block 402, a token may be generated by an electronic device, such as the electronic device 100. The token may be based on a unique identifier of the electronic device 100, a device signature, and a time-stamp of the electronic device 100. The device signature may include a cryptographic key exchanged with an authentication server 204 or a random value generated by the electronic device 100. In an example implementation, the token may be generated by the token generation engine 104.

At block 404, the token is shared with a user device 202. Based on the token, the user device 202 may establish a session with the electronic device 100. The token may be rotated at a fixed time interval, in an example, the token may be modified and shared again after about every 10 seconds. In an example implementation, the token generation engine 104 may share the token with the user device 202. Based on the shared token, the user device 202 may share a transaction request to the electronic device 100 or to the cloud server 206. The transaction request may include a command to be executed and the token received from the electronic device 100.

At block 408, the electronic device 100 may execute a command received from the user device 202. The command is to be executed upon successful validation of the token. In an example, the validation of the token may be performed by the electronic device 100 or by the cloud server 206. In case of the validation by the cloud server 206, the cloud server 206 may forward the command to a respective electronic device based on the unique identifier of the electronic device contained in the token. In an example implementation, the execution engine 106 may execute the command received from the user device 202 based on the successful validation of the token.

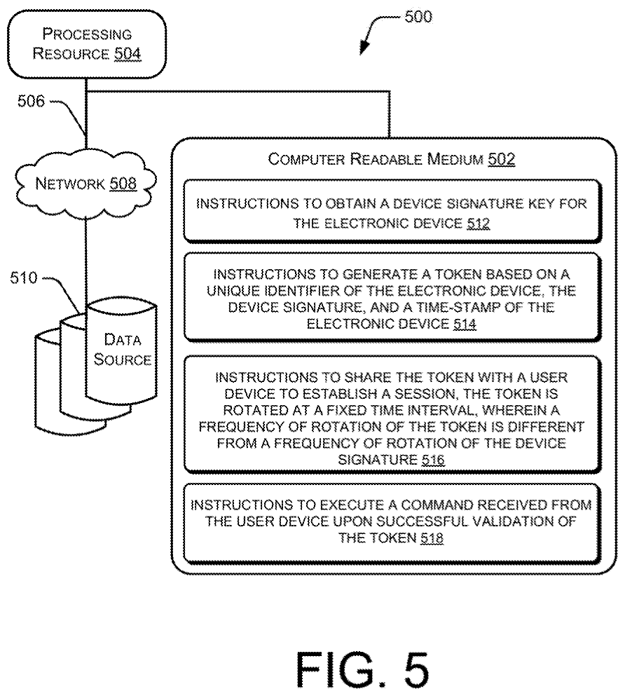

FIG. 5 illustrates an example network environment 500 using a non-transitory computer readable medium 502 for device authentication based on tokens, according to an example of the present subject matter. The network environment 500 may be a public networking environment or a private networking environment. In one example, the network environment 500 includes a processing resource 504 communicatively coupled to the non-transitory computer readable medium 502 through a communication link 508. For example, the processing resource 504 may be a processor of a computing system, such as the electronic device 100, for fetching and executing computer-readable instructions from the non-transitory computer-readable medium 502.

The non-transitory computer readable medium 502 may be, for example, an internal memory device or an external memory device. In one example, the communication link 506 may be a direct communication link, such as one formed through a memory read/write interface. In another example, the communication link 506 may be an indirect communication fink, such as one formed through a network interface. In such a case, the processing resource 504 may access the non-transitory computer readable medium 502 through a network 508. The network 508 may be a single network or a combination of multiple networks and may use a variety of communication protocols.

The processing resource 504 and the non-transitory computer readable medium 502 may also be communicatively coupled to data sources 510 over the network 508. The data sources 510 may include, for example, databases and computing devices. The data sources 510 may be used by the database administrators and other users to communicate with the processing resource 504.

In one example, the non-transitory computer readable medium 502 includes a set of computer readable and executable instructions for device authentication based on tokens. The set of computer-readable instructions may include instructions as explained in conjunction with FIGS. 1 and 2. The set of computer readable instructions, referred to as instructions hereinafter, may be accessed by the processing resource 504 through the communication Sink 508 and subsequently executed to perform acts for device authentication based on tokens.

Referring to FIG. 5, in an example, the non-transitory computer-readable medium 502 may include instructions 512 to obtain a device signature for the electronic device 100. In an example, the device signature may include a cryptographic key received from an authentication server or a random value generated by the electronic device 100. Further, the non-transitory computer-readable medium 502 may include instructions 514 to generate a token based on a unique identifier of the electronic device 100, the device signature, and a time-stamp of the electronic device 100. The non-transitory computer-readable medium 502 may also include instructions 518 to share the token with a user device 202 to establish a session. The token is rotated at a fixed time interval. In an example, a frequency of rotation of the token is different from a frequency of rotation of the device signature.

The non-transitory computer-readable medium 502 may include instructions 518 to execute a command received from the user device upon successful validation of the token. In an example, the non-transitory computer-readable medium 502 may include instructions to receive an indication of validation of the token from a cloud server associated with the electronic device 100. In an alternative example, the non-transitory computer-readable medium 502 may cause the processor to validate the token.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. A method comprising:
generating, by an electronic device, a token, the token being based on a unique identifier of the electronic device, a device signature, and a time-stamp of the electronic device;
sharing the token with a user device to establish a session, wherein the token is rotated at a fixed time interval; and
executing a command received from the user device upon successful validation of the token.

2. The method as claimed in claim 1, wherein the generating comprises registering the electronic device with an authentication server to exchange a cryptographic key as the device signature.

3. The method as claimed in claim 1, wherein the generating comprises obtaining a random value as the device signature, from the electronic device.

4. The method as claimed in claim 1, wherein sharing the token is through wide range communication technologies.

5. The method as claimed in claim 1, wherein sharing the token is through short range communication technologies.

6. The method as claimed in claim 1, wherein executing the command comprises:
receiving a transaction request from the user device, the transaction request comprising the command and the token; and
comparing the device signature of the token in the transaction request with the device signature stored in the electronic device to validate the token.

7. The method as claimed in claim 1, wherein executing the command comprises receiving, from a cloud server, an indication of validation of the token.

8. An electronic device comprising:
a token generation engine to,
generate a token, the token being based on a unique identifier of the electronic device, a device signature, and a time-stamp of the electronic device;
periodically share the token with a user device to establish a to session, wherein a frequency of rotation of the token is different from a frequency of rotation of the device signature; and
an execution engine, coupled to the token generation engine, to,
execute a command received from the user device upon successful validation of the token.

9. The electronic device as claimed in claim 8, wherein the device signature is a random value generated by the electronic device.

10. The electronic device as claimed in claim 8, wherein the device signature is a cryptographic key exchanged with an authentication server.

11. The electronic device as claimed in claim 8 further comprising an authentication engine to register the electronic device with the authentication server to exchange the device signature, wherein the registration is based on a certificate-based authentication.

12. The electronic device as claimed in claim 8, wherein the execution engine is to execute upon receiving an indication of validation of the token from a cloud server associated with the electronic device.

13. A non-transitory computer-readable medium comprising computer-readable instructions, which, when executed by a processor of an electronic device, cause the processor to:
obtain a device signature for the electronic device;
generate a token based on a unique identifier of the electronic device, the device signature, and a time-stamp of the electronic device;
share the token with a user device to establish a session, the token Is rotated at a fixed time interval, wherein a frequency of rotation of the token is different from a frequency of rotation of the device signature; and
execute a command received from the user device upon successful validation of the token.

14. The non-transitory computer-readable medium as claimed in claim 13, wherein to execute the command, the instructions cause the processor to receive an indication of validation of the token from a cloud server associated with the electronic device.

15. The non-transitory computer-readable medium as claimed in claim 13, wherein to execute the command, the instructions cause the processor to validate the token.
